(19) United States
(12) Patent Application Publication
(10) Pub. No.: US 2016/0040820 A1
(43) Pub. Date: Feb. 11, 2016

(54) DOWNSPOUT END CAP

(71) Applicant: Products Innovation Group, Inc., Rochelle, VA (US)

(72) Inventors: Anthony W. MORRIS, Tampa, FL (US); Evelyn M. ROBINS, Ruckersville, VA (US)

(21) Appl. No.: 14/816,602

(22) Filed: Aug. 3, 2015

Related U.S. Application Data
(60) Provisional application No. 62/034,220, filed on Aug. 7, 2014.

(51) Int. Cl. F16L 55/115; F15D 1/04

(52) U.S. Cl. CPC F16L 55/1152; F15D 1/04

(57) ABSTRACT

An end cap for a downspout of a gutter system or the like. The end cap has a screen constructed to extend over an opening at a lower end of a downspout. The screen has peripheral edge portions constructed to extend over adjacent outer end portions of the downspout and to be connected thereto by friction, an adhesive, screws or other connectors. The peripheral edge portions may be integral with the screen or may be separate from and connected to the screen.

### CROSS REFERENCE TO RELATED APPLICATIONS

This application claims the priority of Provisional Patent Application No. 62/034,220 filed on Aug. 7, 2014.

### BACKGROUND OF THE INVENTION

1. Field of the Invention

The present invention relates to an end cap for a downspout and, more particularly, to such an end cap having a new and improved screen construction.

II. Description of the Background Art

Typical downspouts for gutter systems are open at their lower end and thus are subject to being entered by bugs, rodents, snakes or other animals. Also, such open downspouts can have water flowing through them at high velocity during a heavy rain that will create garden and ground erosion around them. Accordingly, a need has arisen for a new and improved downspout system which not will be subject to the above described disadvantages. The end cap of the present invention meets this need.

### BRIEF SUMMARY OF THE INVENTION

The present invention is directed to an end cap for a downspout of a gutter system. The end cap is provided with a screen that extends over the open end of the downspout for the purpose of preventing access into the downspout by bugs, rodents, snakes or other animals. The screen also serves to act as a decelerator to decrease water velocity at the outer end of the downspout to reduce garden and ground erosion near the downspout.

In the case of a completely enclosed gutter system wherein the gutters are covered with screens or covers, the end cap of the present invention serves as a gutter protection performance indicator for the reason that, if any debris is seen at the end cap screen in the downspout, it means that the gutter protection system has a breach and needs maintenance.

The end cap and screen may be of any suitable construction, may be formed of any suitable materials, and may be secured to the lower open end of the downspout in any suitable manner.

### BRIEF DESCRIPTION OF THE DRAWINGS

FIG. 1 is a perspective view of the outer side of one embodiment of a downspout end cap in accordance with the present invention;

FIG. 2 is a perspective view of the inner side of the downspout end cap shown in FIG. 1;

FIG. 3 is a perspective view of the end cap shown in FIGS. 1 and 2 that is mounted in a friction fit or by adhesive on the end of a downspout; and

FIG. 4 is a perspective view of the end cap shown in FIGS. 1 and 2 secured to the outer end of a downspout by screws or other fasteners.

### DETAILED DESCRIPTION OF THE INVENTION

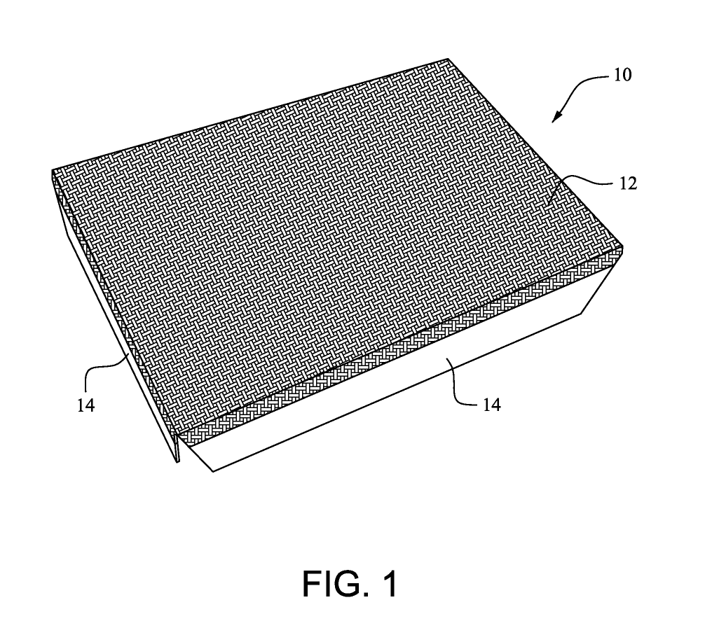

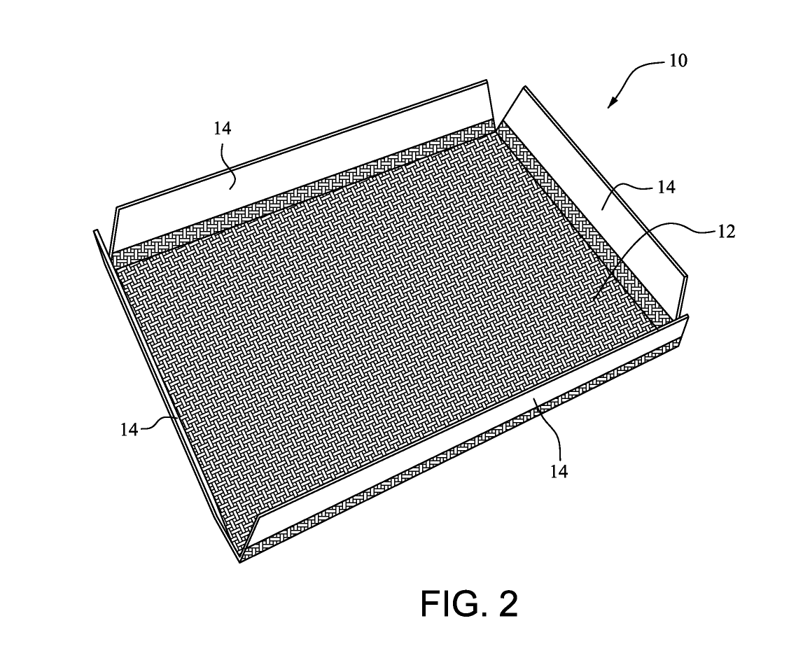

As shown in FIGS. 1 and 2, one embodiment of the end cap 10 of the present invention comprises an outer screen 12 of any suitable type that has inwardly extending peripheral edge portions or flaps 14 for extending over and engaging adjacent outer portions of a downspout when the end cap is mounted thereon. The peripheral edge portions 14 of the screen 12 may be reinforced or coated to facilitate the mounting of the end cap 10 on the lower open end of a downspout or the like.

In one embodiment, the peripheral edge portions 14 of the screen 12 may be dipped in liquid rubber and dried so that they can frictionally engage the adjacent outer edge portions of a downspout to facilitate the mounting of the end cap 10 thereon.

The screen 12 may be formed of any suitable durable material and may be of any suitable mesh size, such as 24 mesh stainless steel.

The peripheral edge portions 14 may be of any suitable construction. For example, the peripheral edge portions 14 could be integral with the screen 12 and treated or coated in any suitable manner for additional strength or density for mounting the end cap on a downspout or the like. Alternately, the peripheral edge portions 14 could be separate or continuous, and could be made separately from the screen 12 and secured thereto in any suitable manner.

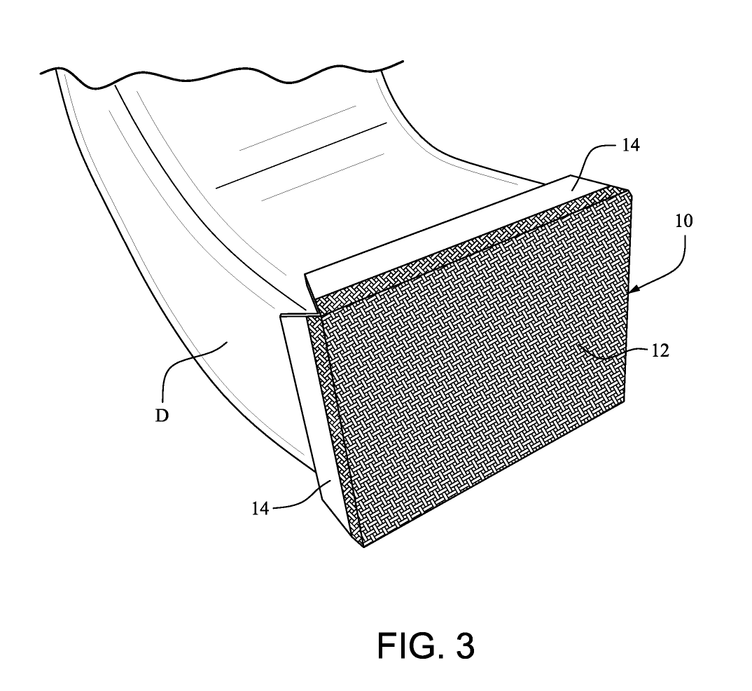

FIG. 3 illustrates the end cap 10 of the present invention mounted on the end of a downspout D and being of a size and shape to fit over the end of the downspout D. The peripheral edge portions 14 of the screen 12 extend over the adjacent outer end portions of the downspout D and can be mounted on the downspout D by a friction fit or by a suitable adhesive or the like.

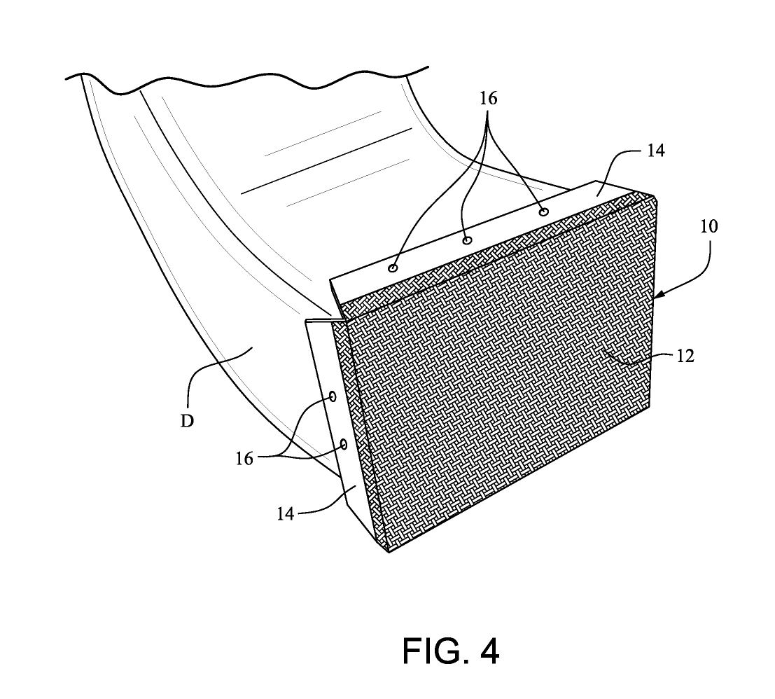

In the embodiment shown in FIG. 4, the end cap 10 is mounted on the outer end of a downspout D and the peripheral edge portions 14 of the screen 12 are secured to the adjacent end portions of the downspout D by screws or the fasteners 16.

From the foregoing description, it will be readily seen that the new and improved end cap 10 of the present invention serves to prevent entry into the downspout D by bugs, rodents, snakes and other animals. Also, the screen 12 of the end cap 10 serves as a decelerator to decrease the velocity of water exiting the downspout to minimize any garden or ground erosion near the downspout. In a closed gutter system, wherein the gutters are covered by screens or other covers, the end cap 10 of the present invention also serves as a gutter protection performance indicator. For example, if any debris is seen at the screen 12 mounted on the downspout, it is an indication that the closed gutter system has a breach and needs maintenance.

It is noted that the end cap 10 may be of any suitable size or shape so that it can be conveniently mounted on the end of a downspout having a comparable size and shape.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. An end cap for a downspout of a gutter system or the like, the end cap comprising a screen constructed to extend over an opening at a lower end of a downspout and having peripheral edge portions constructed to extend over adjacent outer end portions of the downspout to secure the end cap thereto.

2. The end cap of claim 1 wherein the peripheral edge portions are reinforced for frictional engagement with the outer end portions of the downspout.

3. The end cap of claim 2 wherein the peripheral edge portions are coated with rubber.

4. The end cap of claim 1 wherein the peripheral edge portions are flexible and resilient for securing the end cap to a downspout by frictional engagement between the peripheral edge portions and the adjacent outer end portions of the downspout.

5. The end cap of claim 1 wherein the peripheral edge portions are constructed for connection to the adjacent outer end portions of a downspout by an adhesive, screws or other connectors.

6. The end cap of claim 1 wherein the peripheral edge portions are integral with the screen.

7. The end cap of claim 1 wherein the peripheral edge portions are connected to the screen.

8. The end cap of claim 1 wherein the screen is constructed to decrease the velocity of water flowing out of the opening of the downspout.

9. The end cap of claim 1 wherein the screen is constructed to prevent bugs, rodents, snakes and other animals from entering the opening of the downspout.

10. The end cap of claim 1 wherein the screen is formed of 24 mesh stainless steel.
